(19) United States
(12) Patent Application Publication
(10) Pub. No.: US 2014/0001872 A1
(43) Pub. Date: Jan. 2, 2014

(54) POWER SWITCHING CIRCUIT AND ELECTRONIC DEVICE USING SAME

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: JIE-SONG ZHOU, Shenzhen (CN); AN-BANG YU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/869,376

(22) Filed: Apr. 24, 2013

(30) Foreign Application Priority Data
Jun. 28, 2012 (CN) 2012102176659

(51) Int. Cl. H02J 1/00

(52) U.S. Cl. CPC H02J 1/00
USPC 307/85

(57) ABSTRACT

A power switching circuit is connected to an external power source, a battery, and a load. The power switching circuit includes a voltage converter, a prevention unit, a detecting unit, and a switch. The voltage converter converts a first primary voltage supplied by the external power source to a secondary voltage. The prevention unit allows the secondary voltage to be transmitted to the load, the secondary voltage powering the load. The detecting unit generates a first level signal when the external power source fails to output the first primary voltage. The switch is turned on to transmit a second primary voltage supplied by the battery to the load and the prevention unit in response to the first level signal. The second primary voltage powers the load. The prevention unit prevents the second primary voltage from being transmitted to the voltage converter.

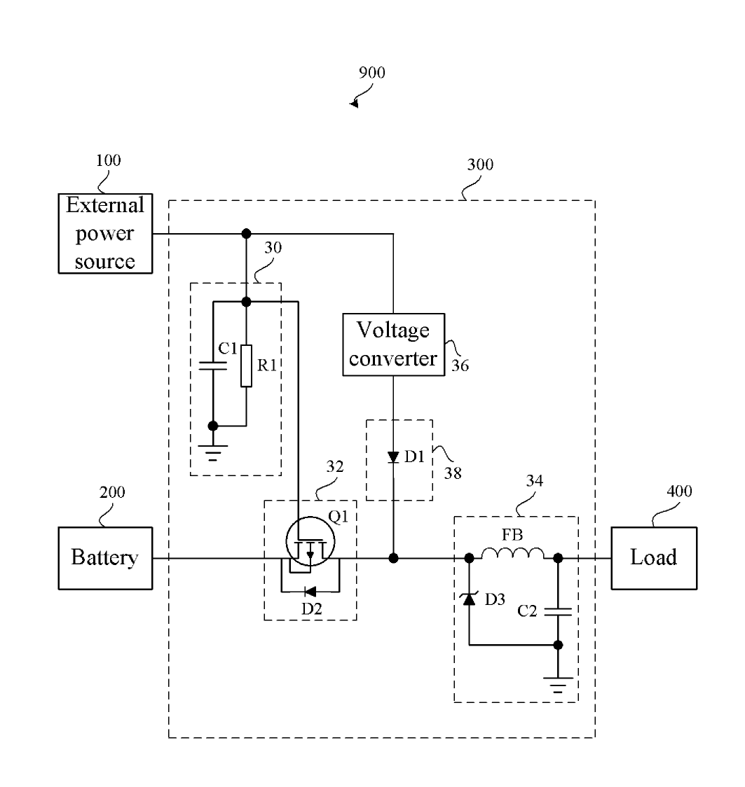

### BACKGROUND

1. Technical Field

The disclosed embodiments relate to a power switching circuit and an electronic device using the same.

2. Description of Related Art

A typical power switching circuit is connected to an external power source, a battery, and a load. The power switching circuit includes a processing unit, and a voltage converter. When the external power source outputs a first primary voltage, the processing unit controls the voltage converter to convert the first primary voltage to a first operating voltage, and the first operating voltage powers the load. When the external power source stops outputting the first primary voltage, the processing unit controls the voltage converter to convert a second primary voltage supplied by the battery to a second operating voltage, and the second operating voltage powers the load.

However, the conversion of battery power by the voltage converter in itself consumes power and thus the discharge time during which the battery powers the load is shortened.

Therefore, there is room for improvement in the art.

### BRIEF DESCRIPTION OF THE DRAWINGS

Many aspects of the embodiments can be better understood with reference to the drawing. The components in the drawing are not necessarily drawn to scale, the emphasis instead being placed upon clearly illustrating the principles of the present embodiments. Moreover, in the drawing, like reference numerals designate corresponding parts throughout one view.

The FIGURE is a schematic block diagram showing an electronic device in accordance with one embodiment.

### DETAILED DESCRIPTION

Referring to the FIGURE, an electronic device 900 in accordance with one embodiment is illustrated. The electronic device 900 includes an external power source 100, a battery 200, a power switching circuit 300, and a load 400. The power switching circuit 300 is connected to the external power source 100, the battery 200, and the load 400. In the embodiment, the electronic device 900 is a digital versatile disc (DVD) player, the external power source 100 may be an AC power source or a DC power source.

The power switching circuit 300 includes a detecting unit 30, a switch 32, a protection unit 34, a voltage converter 36, and a prevention unit 38.

The detecting unit 30 is connected to the external power source 100 and the switch 32. The detecting unit 30 detects whether the external power source 100 outputs the first primary voltage, generates a first level signal when the external power source 100 fails to output the first primary voltage, and generates a second level signal when the external power source 100 outputs the first primary voltage. In the embodiment, the first level signal is a low level signal, the second level signal is a high level signal.

The switch 32 is connected between the battery 200 and the protection unit 34. The switch 32 is further connected between the battery 200 and the prevention unit 38. The switch 32 is turned on to transmit a second primary voltage supplied by the battery 200 to the protection unit 34 and the prevention unit 38 in response to the first level signal, and the second primary voltage powers the load 400 through the protection unit 34, that is to say the battery 200 powers the load 400 via the conducted switch 32 and the protection unit 34. The protection unit 34 filters the second primary voltage and provides protection against ESD and EMI immunity for the load 400.

The switch 32 is turned off to stop transmitting the second primary voltage to the protection unit 34 and the prevention unit 38 in response to the second level signal, thus the battery 200 stops powering the load 400. As mentioned above, when the external power source 100 outputs the first primary voltage, the detecting unit 30 generates the second level signal, and the voltage converter 36 converts the first primary voltage to the secondary voltage.

The prevention unit 38 is connected between the voltage converter 36 and the protection unit 34, the prevention unit 38 is further connected between the voltage converter 36 and the switch 32. When the switch 32 is turned on by the first level signal, the battery 200 then powers the load 400 via the conducted switch 32 and the protection unit 34, and the prevention unit 38 prevents the second primary voltage supplied by the battery 200 from being transmitted to the voltage converter 36, thus the voltage converter 36 cannot consume any electrical energy of the battery 200, compared to prior art. The discharge time during which the battery 200 powers the load 400 is thus significantly extended. Furthermore, the life span of the battery 200 may be extended.

When the switch 32 is turned off by the second level signal, the prevention unit 38 allows the secondary voltage from the voltage converter 36 to be transmitted to the protection unit 34 and the switch 32, therefore, the secondary voltage powers the load 400 through the protection unit 34, and the switch 32 allows the secondary voltage to be transmitted to the battery 200, therefore the secondary voltage charges up or recharges the battery 200.

In detail, the detecting unit 30 includes a resistor R1 and a first capacitor C1, a first end of the first capacitor C1 is connected to the external power source 100, the voltage converter 36, and the switch 32, a second end of the first capacitor C1 is grounded. The resistor R1 is connected between the first end and the second end of the first capacitor C1. When the external power source 100 outputs the first primary voltage, the first primary voltage charges up the first capacitor C1, therefore, the detecting unit 30 generates the high level signal (second level signal). When the external power source 100 stops outputting the first primary voltage, the first capacitor C1 is discharged via the first resistor R1, therefore, the detecting unit 30 generates the low level signal (first level signal).

The prevention unit 38 includes a first diode D1, an anode of the first diode D1 is connected to the voltage converter 36, and a cathode of the first diode D1 is connected to the switch 32 and the protection unit 34.

The switch 32 includes a transistor Q1 and a second diode D2, a gate of the transistor Q1 is connected to the first end of the first capacitor C1, a source of the transistor Q1 is connected to the battery 200, and a drain of the transistor Q1 is connected to the cathode of the first diode D1 and the protection unit 34. An anode of the second diode D2 is connected to the drain of the transistor Q1, a cathode of the second diode D2 is connected to the source of the transistor Q1. The secondary voltage outputted by the voltage converter 36 charges up the battery 200 via the first diode D1 and the second diode D2. The transistor Q1 is turned on by the first level signal, and the transistor Q1 is turned off by the second level signal. In this embodiment, the transistor Q1 is p type metal oxide semiconductor field effect transistor (MOSFET).

The protection unit 34 comprises a ferrite bead FB, a zener diode D3, and a second capacitor C2. A first end of the ferrite bead FB is connected to the cathode of the first diode D1 and the anode of the second diode D2, a second end of the ferrite bead FB is connected to the load 400. A cathode of the zener diode D3 is connected to the first end of the ferrite bead FB, an anode of the zener diode D3 is grounded. A first end of the second capacitor C2 is connected to the second end of the ferrite bead FB, a second end of the second capacitor C2 is grounded. The second capacitor C2 carries out the filtering function of the protection unit 34, the zener diode D3 carries out the anti-ESD function of the protection unit 34, and the ferrite bead FB substantially provides EMI immunity.

Alternative embodiments will become apparent to those skilled in the art without departing from the spirit and scope of what is claimed. Accordingly, the present disclosure should not be deemed to be limited to the above detailed description, but rather only by the claims that follow and the equivalents thereof.

What is claimed is:

1. A power switching circuit connected to an external power source, a battery, and a load, the power switching circuit comprising:
a voltage converter converting a first primary voltage supplied by the external power source to a secondary voltage;
a prevention unit allowing the secondary voltage to be transmitted to the load, the secondary voltage powering the load;
a detecting unit detecting whether the external power source outputs the first primary voltage, generating a first level signal when the external power source fails to output the first primary voltage; and
a switch being turned on to transmit a second primary voltage supplied by the battery to the load and the prevention unit in response to the first level signal, the second primary voltage powering the load;
wherein the prevention unit prevents the second primary voltage from being transmitted to the voltage converter.

2. The power switching circuit of claim 1, wherein the detecting unit generates a second level signal when the external power source outputs the first primary voltage; the switch is turned off to stop transmitting the second primary voltage to the load and the prevention unit in response to the second level signal.

3. The power switching circuit of claim 1, wherein the prevention unit further allows the secondary voltage to be transmitted to the switch, the switch allows the secondary voltage to be transmitted to the battery, and the secondary voltage charges up the battery.

4. The power switching circuit of claim 3, wherein the prevention unit comprises a first diode, an anode of the first diode is connected to the voltage converter, a cathode of the first diode is connected to the switch and the load.

5. The power switching circuit of claim 2, wherein when the external power source outputs the first primary voltage, the detecting unit is charged up by the first primary voltage to generate the second level signal; when the external power source fails to output the first primary voltage, the detecting unit is discharged to generate the second level signal.

6. The power switching circuit of claim 5, wherein the detecting unit comprises a resistor and a first capacitor, a first end of the first capacitor is connected to the external power source, the voltage converter, and the switch; a second end of the first capacitor is grounded; the resistor is connected between the first end and the second end of the first capacitor.

7. The power switching circuit of claim 3, wherein the switch comprises a transistor and a second diode, a gate of the transistor is connected to the detecting unit, a source of the transistor is connected to the battery, and a drain of the transistor is connected to the prevention unit and the load; an anode of the second diode is connected to the drain of the transistor, a cathode of the second diode is connected to the source of the transistor; the secondary voltage charges up the battery via the second diode; the transistor is turned on by the first level signal.

8. The power switching circuit of claim 1, further comprising a protection unit, wherein the protection unit comprises a ferrite bead, a zener diode, and a second capacitor, a first end of the ferrite bead is connected to the prevention unit and the switch, a second end of the ferrite bead is connected to the load; a cathode of the zener diode is connected to the first end of the ferrite bead, an anode of the zener diode is grounded; a first end of the second capacitor is connected to the second end of the ferrite bead, a second end of the second capacitor is grounded.

9. The power switching circuit of claim 1, wherein the first level signal is a low level signal, the second level signal is a high level signal.

10. An electronic device, comprising:
an external power source;
a battery;
a load; and
a power switching circuit connected to the external power source, the battery, and the load, the power switching circuit comprising:
a voltage converter converting a first primary voltage supplied by the external power source to a secondary voltage;
a prevention unit allowing the secondary voltage to be transmitted to the load, the secondary voltage powering the load;
a detecting unit detecting whether the external power source outputs the first primary voltage, generating a first level signal when the external power source fails to output the first primary voltage; and
a switch being turned on to transmit a second primary voltage supplied by the battery to the load and the prevention unit in response to the first level signal, the second primary voltage powering the load;
wherein the prevention unit prevents the second primary voltage from being transmitted to the voltage converter.

11. The electronic device of claim 10, wherein the detecting unit generates a second level signal when the external power source outputs the first primary voltage; the switch is turned off to stop transmitting the second primary voltage to the load and the prevention unit in response to the second level signal.

12. The electronic device of claim 10, wherein the prevention unit further allows the secondary voltage to be transmitted to the switch, the switch allows the secondary voltage to be transmitted to the battery, and the secondary voltage charges up the battery.

13. The electronic device of claim 12, wherein the prevention unit comprises a first diode, an anode of the first diode is connected to the voltage converter, a cathode of the first diode is connected to the switch and the load.

14. The electronic device of claim 11, wherein when the external power source outputs the first primary voltage, the detecting unit is charged up by the first primary voltage to generate the second level signal; when the external power source fails to output the first primary voltage, the detecting unit is discharged to generate the second level signal.

15. The electronic device of claim 14, wherein the detecting unit comprises a resistor and a first capacitor, a first end of the first capacitor is connected to the external power source, a second end of the first capacitor is grounded; the resistor is connected between the first end and the second end of the first capacitor, the first end of the first capacitor is further connected to the switch.

16. The electronic device of claim 12, wherein the switch comprises a transistor and a second diode, a gate of the transistor is connected to the detecting unit, a source of the transistor is connected to the battery, and a drain of the transistor is connected to the prevention unit and the load; an anode of the second diode is connected to the drain of the transistor, a cathode of the second diode is connected to the source of the transistor; the secondary voltage charges up the battery via the second diode; the transistor is turned on by the first level signal.

17. The electronic device of claim 10, further comprising a protection unit, wherein the protection unit comprises a ferrite bead, a zener diode, and a second capacitor, a first end of the ferrite bead is connected to the prevention unit and the switch, a second end of the ferrite bead is connected to the load; a cathode of the zener diode is connected to the first end of the ferrite bead, an anode of the zener diode is grounded; a first end of the second capacitor is connected to the second end of the ferrite bead, a second end of the second capacitor is grounded.

18. The electronic device of claim 10, wherein the first level signal is a low level signal, the second level signal is a high level signal.

19. The electronic device of claim 16, wherein the transistor is p type metal oxide semiconductor field effect transistor.
